(19) United States
(12) Patent Application Publication
(10) Pub. No.: US 2026/0140907 A1
(43) Pub. Date: May 21, 2026

(54) INTERNAL COMMUNICATION LINK

(71) Applicants: Arm Limited, Cambridge (GB); Alphawave Semi, Inc., San Jose, CA (US)

(72) Inventors: Abhay TAVARAGIRI, Liberty Hill, TX (US); Ashok Kumar TUMMALA, Cedar Park, TX (US); Travis Bailey HAMILTON, Cedar Park, TX (US); Randall John PASCARELLA, Round Rock, TX (US); Cesar Aaron RAMIREZ, Pflugerville, TX (US); Viswanath CHAKRALA, Bangalore (IN); Charles Andrew GIEFER, Spicewood, TX (US); Gopi KRISHNAMURTHY, Plano, TX (US)

(21) Appl. No.: 19/092,347

(22) Filed: Mar. 27, 2025

(30) Foreign Application Priority Data
Nov. 15, 2024 (IN) 202411088573

(51) Int. Cl. G06F 13/40

(52) U.S. Cl. CPC G06F 13/4027; G06F 2213/40

(57) ABSTRACT

An apparatus comprises bridge circuitry configured to bridge between a memory system interconnect and a port controller. In a first state, the bridge circuitry is configured to control the internal communication link interface to transmit a given type of packet to the port controller using a first type of credit. In a second state, the bridge circuitry is configured to control the internal communication link interface to transmit the given type of packet to the port controller without using the first type of credit. The first type of credit represents availability of buffer storage at the link partner.

### CROSS-REFERENCE TO RELATED APPLICATION

This application claims priority to IN Application No. 202411088573 filed Nov. 15, 2024, the entire contents of which are hereby incorporated by reference.

### BACKGROUND

### Technical Field

The present technique relates to the field of data processing.

### Technical Background

A data processing apparatus may communicate with one or more external link partners (e.g. input/output devices, other chiplets in a distributed compute system, etc.) via an external communication link. An external link protocol may define the communication format for data exchanged via the external communication link, so that a data processing apparatus and a link partner provided by different vendors can be inter-operable with each other.

### SUMMARY

At least some examples of the present technique provide an apparatus, comprising:

bridge circuitry configured to bridge between a memory system interconnect and a port controller, the port controller for communicating via an external communication link with a link partner, the bridge circuitry comprising an internal communication link interface configured to transmit packets via an internal communication link to the port controller; wherein

in a first state of the bridge circuitry, the bridge circuitry is configured to control the internal communication link interface to transmit a given type of packet to the port controller using a first type of credit; and

in a second state of the bridge circuitry, the bridge circuitry is configured to control the internal communication link interface to transmit the given type of packet to the port controller without using the first type of credit;

wherein the first type of credit represents availability of buffer storage at the link partner.

At least some examples provide an apparatus, comprising:
a port controller configured to control communication via an external communication link with a link partner, the port controller configured to receive packets via an internal communication link from bridge circuitry; wherein

in a first state of the port controller, the port controller is configured to receive packets via the internal communication link from the bridge circuitry and indicate availability of a first type of credit to the bridge circuitry; and

in a second state of the port controller, the port controller is configured to receive packets via the internal communication link from the bridge circuitry without indicating availability of the first type of credit to the bridge circuitry;

wherein the first type of credit represents availability of buffer storage at the link partner.

At least some examples provide a method, comprising:
transmitting packets via an internal communication link from bridge circuitry, for bridging between a memory system interconnect and a port controller, the port controller for communicating via an external communication link with a link partner;

in a first state, transmitting a given type of packet via the internal communication link using a first type of credit; and

in a second state, transmitting the given type of packet via the internal communication link without using the first type of credit;

wherein the first type of credit represents availability of buffer storage at the link partner. At least some examples provide a method, comprising:

controlling communication via an external communication link for communicating with a link partner;

in a first state, receiving packets via an internal communication link from bridge circuitry and indicating availability of a first type of credit to the bridge circuitry; and

in a second state, receiving packets via the internal communication link from the bridge circuitry without indicating availability of the first type of credit to the bridge circuitry;

wherein the first type of credit represents availability of buffer storage at the link partner.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of a data processing system;

FIG. 2 schematically illustrates use of various communication protocols within the data processing system;

FIG. 3 illustrates an example of a layered protocol (in particular, PCIe) for communication on an external communication link;

FIG. 4 illustrates an example packet format for the PCIe standard;

FIG. 5 illustrates a credit mechanism and logical connections within the data processing system;

FIG. 6 illustrates an example of bridge circuitry;

FIG. 7 illustrates an example of a port controller;

FIG. 8 is a state diagram illustrating an application layer state machine for a transmitter;

FIG. 9 is a state diagram illustrating an application layer state machine for a receiver;

FIG. 10 is a flow diagram illustrating a method performed by bridge circuitry;

FIG. 11 is a flow diagram illustrating a method performed by a port controller;

FIG. 12 is a flow diagram illustrating a method performed by a transmitter;

FIG. 13 is a flow diagram illustrating a method performed by a receiver;

FIG. 14 illustrates an example of use of an internal link protocol for conveying transaction layer packets of an external link protocol between the bridge circuitry and the port controller;

FIG. 15 illustrates various communication layers in use within the system; and

FIG. 16 illustrates a system and a chip-containing product.

### DESCRIPTION OF EXAMPLES

An apparatus comprises bridge circuitry to bridge between a memory system interconnect and a port controller. The memory system interconnect may for instance be used to connect internal units of the apparatus, such as compute units and memory system storage. The port controller may be provided to manage communications via an external communication link with a link partner. The bridge circuitry may hence map between packets used for the external communication link and memory system interconnect transactions defined according to a memory system interconnect protocol used by the memory system interconnect.

The bridge circuitry and the port controller are coupled via an internal communication link, and an internal communication link interface is provided by the bridge circuitry to transmit packets via the internal communication link to the port controller.

In a first state of the bridge circuitry, the bridge circuitry is configured to control the internal communication link interface to transmit a given type of packet to the port controller using a first type of credit. For example, a counter may be used to track an available number of the first type of credit, and the counter may be decremented when the given type of packet is transmitted to the port controller. If there are no available credits, then the bridge circuitry may prohibit the internal communication link interface from transmitting the given type of packet. Controlling communication on the internal communication link using such a credit scheme can provide a guarantee that a receiver of the given type of packet will have enough buffer capacity to receive the given packet, and avoid cases in which the bridge circuitry transmits a greater number of the given type of packet than can be handled by the receiver of those packets. The given type of packet is not particularly limited, and may include posted packets (for which no response is required), non-posted packets (for which a response is requested), and completion packets (providing a response to an earlier non-posted packet). In some examples, the bridge circuitry may control transmission of posted, non-posted, and completion packets using different credits (which may each be a first type of credit).

According to a typical approach, a type of credit used to control communication from the bridge circuitry to the port controller may indicate availability of buffer storage at the port controller. This might be considered typical since the port controller might typically be seen as the receiver of packets transmitted over the internal communication link. However, according to examples of the present technique the first type of credit represents availability of buffer storage at the link partner (with which the port controller manages communications). This is counter-intuitive since in this case the credits for managing communication between the bridge circuitry and the port controller do not represent buffer availability at the port controller. However, the inventors have recognized that, generally, packets transmitted over the internal communication link from the bridge to the port controller may be further transmitted from the port controller to the link partner via the external communication link. Hence, buffer availability at the link partner (e.g., an endpoint device, or an intermediate switch) may be used to control whether the bridge can transmit the given type of package to the port controller. By controlling communication on the internal communication link using a first type of credit representing availability of buffer storage at the link partner, this can reduce the requirement to provide intermediary buffering within the port controller, and can hence provide area savings and enable the port controller to be implemented more easily.

In a second state of the bridge circuitry, the bridge circuitry is configured to control the internal communication link interface to transmit the given type of packet to the port controller without using the first type of credit. The inventors have realized that when the first type of credit represents availability of buffer storage at the link partner, if the bridge circuitry only supported transmission of the given type of packet in the first state then when the external communication link between the link partner and the port controller is not available it may not be possible to send the given type of packet from the bridge circuitry to the port controller. In particular, when the external communication link is unavailable then it is not possible to transmit packets to the link partner, and hence availability of buffer storage at the link partner cannot be changed. This means that an available number of the first type of credit (representing availability of buffer storage at the link partner) cannot be changed, and hence a packet cannot be sent using the first type of credit. Therefore, the first type of credit cannot be used to control communication when the external communication link between the port controller and the link partner is unavailable. However, the inventors have realized that even when the external communication link is not available there may be a requirement for packets to be transmitted from the bridge circuitry to the port controller. For instance, in addition to a logical connection between the bridge circuitry and the link partner, there may also be a logical connection between the bridge circuitry and the port controller which may be required even when the external communication link is unavailable. By supporting the second state of the bridge circuitry, a packet which may in the first state require the first type of credit for communication may still be able to be sent from the bridge circuitry to the port controller when a mechanism for tracking the first type of credit is not available, and hence the logical connection between the bridge circuitry and the port controller can be maintained even when the external communication link is unavailable. The bridge circuitry may for example enter the second state from the first state in response to determining that the external communication link is unavailable.

In some examples, the bridge circuitry may be configured to receive a credit exchange message from the port controller indicating availability of the first type of credit. The bridge circuitry may for example be configured to increment a counter tracking the first type of credit in response to the credit exchange message from the port controller, and hence this may provide a mechanism by which the bridge circuitry can determine that additional buffer capacity has been made available at the link partner and hence additional packets of the given type may be sent via the internal communication link to the port controller. The credit exchange message may in some examples be received by the bridge circuitry over a side channel, separate from a main channel used for the transmission of packets between the bridge circuitry and the port controller. When the external communication link is not available, the port controller may be unable to determine availability of buffer storage in the link partner and hence may be unable to issue the credit exchange message to the bridge circuitry.

As mentioned above, in the first state the bridge circuitry may be configured to prohibit the internal communication link interface from transmitting the given type of packet to the port controller when there is no availability of the first type of credit.

A manner in which the bridge circuitry controls communication of packets in the second state may not be particularly limited. For a first type of packet it may be desirable in the second state to ensure that there is sufficient buffer availability at the port controller to receive the first type of packet. Therefore, in some examples, a credit mechanism may also be used to control communication of certain packets from the bridge circuitry to the port controller even in the second state of the bridge circuitry. For example, in the second state of the bridge circuitry, the bridge circuitry may be responsive to the given type of packet being the first type of packet to transmit the first type of packet using a second type of credit representing availability of buffer storage at the port controller (in contrast to the first type of credit representing availability of buffer storage at the link partner). The buffer storage at the port controller may be dedicated buffer storage for use with the second type of credit. For example, the port controller may comprise a pre-allocated amount of buffer storage set aside to receive packets from the bridge circuitry tracked with the second type of credit. The bridge circuitry may track an amount of the pre-allocated buffer storage still available at the port controller using the second type of credit, and hence may use the second type of credit to control communication with the port controller even when the external communication link is unavailable.

The first type of packet is not particularly limited, and the first type of packet may be defined in various ways. In some examples, every packet may be considered the first type of packet and hence the second type of credit may be used to control communication of all packets in the second state of the bridge circuitry. However, in some examples the first type of packet may be a packet which requests a completion response. Hence, the second type of credit may only be used for controlling communication of packets for which a response is expected from the port controller. By ensuring that the first type of packet is only sent when there is available buffer storage at the port controller, this can avoid situations where the first type of packet is sent when the port controller is unable to buffer the packet and is hence unable to respond to the packet in due course, and hence this can avoid issues at the bridge circuitry which may otherwise be stuck awaiting a response from a packet which was never correctly received by the port controller.

In some examples, the first type of packet may not include packets for which the bridge circuitry does not expect a response, and hence sending of such packets may not require an available second type of credit, and may not cause a number of available second type of credit to be reduced.

In some examples, the bridge circuitry may be configured to manage an available number of the second type of credit independent of credit exchange messages from the port controller. For example, the credit exchange messages may be used exclusively by the port controller to indicate an available number of the first type of credit, and hence the available number of the second type of credit may be managed separately from the credit exchange messages.

In some configurations, for example, the bridge circuitry may be configured to increment an available number of the second type of credit in response to receipt of a completion packet from the port controller. The completion packet may for example indicate that the first type of packet has been handled by the port controller and no longer occupies buffer storage at the port controller, and hence can be seen as an indication that availability of buffer storage at the port controller has increased. An available number of the second type of credit may hence indicate a difference between a total amount of buffer storage at the port controller and a number of currently outstanding requests occupying buffer storage at the port controller (which can be considered no longer outstanding when a completion response is received).

In some examples, in the first state of the bridge circuitry, the bridge circuitry may be configured to control the internal communication link interface to transmit a packet targeting the port controller via the internal communication link using the second type of credit. Hence, the bridge circuitry may be configured to use both the first type of credit and the second type of credit in the first state, and is not restricted to using the second type of credit only in the second state. As the first type of credit represents availability of buffer storage at the link partner, and not the port controller, it may not be appropriate to use the first type of credit to control transmission of packets targeting the port controller (even in the first state) as this may not guarantee that the port controller is able to handle said packet. Hence, even in the first state the bridge circuitry may use the second type of credit, representing availability of buffer storage at the port controller, to control transmission of packets targeting the port controller. In this way, the bridge circuitry is configured to support both a logical connection between the bridge circuitry and the link partner (e.g., via the first type of credit), and a logical connection between the bridge circuitry and the port controller (e.g., via the second type of credit). In the second state, the bridge circuitry may use the second type of credit for a wider range of packets than in the first state, as in the second state the bridge circuitry may use the second type of credit for any packet requesting a response (e.g., from the port controller or from the link partner), which may be a wider range of packets than in the first state where the bridge circuitry may only use the second type of credit for packets targeting the port controller (and, in some cases, only for packets requesting a response from the port controller).

In some examples, in the second state of the bridge circuitry, the bridge circuitry may be responsive to the given type of packet being a second type of packet to transmit the second type of packet without using any credits. As mentioned above, there may be some types of packet for which it makes no difference to the bridge circuitry whether the packet is correctly received or not by the port controller. For such packets, the bridge circuitry may hence transmit the packet to the port controller without using a credit scheme, and hence without any indication of buffer availability at the port controller. For the second type of packet, the bridge circuitry may transmit the packet without decrementing any credit counters, and without first checking availability of any type of credit.

As with the first type of packet, the second type of packet is not particularly limited and various packets could be considered the second type of packet in different implementations. In some examples the second type of packet may comprise packets for which no response is requested. Sending such packets even when there is no buffer availability at the port controller may not lead to problems at the bridge circuitry, as from the perspective of the bridge circuitry there may be no difference whether the packet is received correctly or not by the port controller, as in either case the bridge circuitry will not be waiting for a response from the port controller. Such packets may for example include posted and completion packets directed to the link partner, which in any case may have little importance in the second state of the bridge circuitry when the logical connection between the bridge and the link partner is unavailable (due to the external communication link being unavailable).

In some examples, in a third state of the bridge circuitry, the bridge circuitry may be configured to prohibit the internal communication link interface from transmitting the given type of message via the internal communication link. Hence, in addition to the first and second states of the bridge circuitry in which the given type of packet is permitted to be transmitted from the bridge circuitry to the port controller, in a third state of the bridge circuitry the transmission of the given type of packet may be prohibited. If the second state were not provided, then when the external communication link is unavailable the bridge circuitry may have been forced to enter the third state, as the first type of credit may not be usable in the absence of the external communication link as discussed above. However, by providing the second state of the bridge circuitry, the given type of packet may be transmitted (and hence the third state avoided) even in the absence of the external communication link.

In some examples, the bridge circuitry may be configured to operate in one of six total states, the six states comprising the first state, the second state, and the third state as discussed above, in addition to three additional states each for transitioning into the first state, the second state, and the third state. Hence, the bridge circuitry may control the transmission of packets to the port controller by providing a state machine having six states. This may provide an alternative to a more conventional state machine having four states: the first state, third state, and two additional states for transitioning into the first state and third state. Providing the second state (and its corresponding transitional state), as discussed above, can allow the bridge circuitry to control a logical connection between the bridge circuitry and the port controller even in the absence of the external communication link. The state machine provided by the bridge circuitry may be an application layer state machine, controlling the logical connections of the bridge circuitry at an application layer.

As discussed above, by supporting a second state in which a given packet may be transmitted without using a first type of credit, an apparatus can provide bridge circuitry which enables a logical connection to a port controller even when that port controller lacks an external communication link with a link partner for providing the first type of credit. In some examples, the apparatus may also comprise the port controller. In other examples, the port controller may be a separate component from the bridge circuitry, provided as part of a separate apparatus. The bridge circuitry and port controller may be separately licensed circuit components, which may be provided by different circuit design vendors. Hence, the bridge circuitry and port controller may in some cases be viewed as standalone components which may be marketed independently for inclusion in a larger system designed by a downstream party in a chain of design/manufacture.

The port controller may be configured to behave in a new way, particularly in view of the bridge circuitry being configured to operate in the second state. Hence, some further examples of the present technique provide an apparatus comprising a port controller configured to control communication via an external communication link with a link partner, the port controller configured to receive packets via an internal communication link from the bridge circuitry described above.

In a first state of the port controller, the port controller is configured to receive packets via the internal communication link from the bridge circuitry and indicate availability of a first type of credit to the bridge circuitry, the first type of credit representing availability of buffer storage at the link partner. Hence, in the first state, the port controller enables a communication link to be established between the bridge circuitry and the port controller, and supports a credit scheme for transmitting packets from the bridge circuitry to the port controller in which credits representing buffer storage availability at the link partner are advertised to the bridge circuitry, reducing buffering in the port controller as discussed above. The port controller may for example indicate availability of the first type of credit by issuing credit exchange messages (e.g., via a side band of the internal communication link) identifying availability of the first type of credit.

The first state of the port controller may correspond to the first state of the bridge circuitry, in that a port controller in the first state supports communication with bridge circuitry in the first state.

As discussed above, if an external communication link between the port controller and the link partner is unavailable then the port controller may be unable to advertise the first type of credit to the bridge circuitry (as the port controller may be unable to determine buffer availability at the link partner without the external communication link). Therefore it might typically be assumed that the port controller may be unable to communicate with the bridge circuitry at all when the external communication link (and hence the first type of credit) is unavailable. However, according to the present techniques the port controller supports a second state in which the port controller is configured to receive packets via the internal communication link from the bridge circuitry without indicating availability of the first type of credit to the bridge circuitry. This can allow the port controller to maintain a communication link with the bridge circuitry even when the external communication link is unavailable in situations where a first type of credit used to control communication between the bridge circuitry and port controller represents buffer availability at the link partner.

In some examples, in both the first state of the port controller and the second state of the port controller, the port controller may be configured to issue response packets in response to at least a subset of packets received from the bridge circuitry. Hence, although in the second state the port controller is unable to indicate an availability of the first type of credit the port controller may nevertheless be able to provide the bridge circuitry with response packets, and hence a logical communication path can be maintained between the bridge circuitry and the port controller. In particular, in the second state the bridge circuitry may be configured to issue completion packets in response to non-posted packets targeting either the port controller itself or the link partner. Such completion packets may be used by the bridge circuitry to track an availability of buffer storage at the port controller (using a second type of credit) as discussed earlier.

Although the port controller may be configured to receive packets from the bridge circuitry in both the first state and the second state, the manner in which the port controller handles packets may differ between states. In some examples, in the first state of the port controller, the port controller may be configured to forward a given type of packet received from the bridge circuitry to the link partner. The given type of packet may for example be a packet intended for transmission to the link partner over the external communication link. As mentioned above, in the first state the port controller may not buffer the given type of packet received from the bridge circuitry, instead directly forwarding the packet for buffering at the link partner, and hence the first type of credit may represent to the bridge circuitry buffer availability at the link partner rather than availability at the port controller.

The given type of packet is not particularly limited, but may include packets for which no response is requested, such packets being referred to earlier as posted or completion packets.

In the second state of the port controller, which may be entered for example when the external communication link is not available, the port controller may instead be configured to drop the given type of packet received from the bridge circuitry. Hence, although the port controller may receive the given type of packet from the bridge circuitry, the port controller (which may not be configured to buffer the given type of packet) may drop the external link protocol packet without performing any actions to handle the external link protocol packet in the second state.

The port controller may however not drop every packet received from the bridge circuitry in the second state. Certain packets received from the bridge circuitry may request a response, and dropping such packets at the port controller may cause the bridge circuitry to be stalled awaiting the response. The port controller may therefore comprise buffer storage for storing a given subset of packets received from the bridge circuitry, wherein in the second state of the port controller, the given subset comprises packets for which a response is requested. By enabling packets requesting a response to be buffered (rather than dropped, for example), the port controller is able to allow responses to be generated for those packets.

In the second state of the port controller, the given subset may include packets for which a response is requested either from the port controller or from the link partner. Whilst in the first state, the link partner may be responsible for providing responses requested from the link partner, in the second state the external communication link may not be available and hence the port controller itself may be configured to generate responses to all packets requesting a response (hence buffering all packets for which a response is requested).

The port controller may also be configured to buffer a given subset of packets received from the bridge circuitry in the first state. In the first state, the given subset may for example comprise packets for which a response is requested from the port controller specifically (rather than the link partner).

By enabling packets to be buffered in the first state and the second state, the port controller supports a logical connection between the bridge circuitry and the port controller, in addition to the logical connection between the bridge circuitry and link partner which is supported by forwarding packets and indicating availability of the first type of credit.

The port controller may also be configured to support a third logical connection, between the port controller and the link partner. For example, the port controller may be configured to indicate a lower availability of the first type of credit to the bridge circuitry than an amount of buffer storage indicated to the port controller by the link partner. For example, although the link partner may have X available buffer slots for handling packets transmitted by the port controller, the port controller may be configured to indicate X-N (X-N<X) available buffer slots to the bridge circuitry. The port controller may therefore be considered to reserve (or “steal”) N buffer slots by indicating fewer slots to the bridge circuitry than the total allocation available for packets transmitted from the port controller.

The port controller may use reserved credits representing the reserved link partner buffer storage to handle direct communication between the bridge circuitry and the link partner. The port controller may for example be configured to transmit a particular type of packet to the link partner using a reserved type of credit, the reserved type of credit corresponding to a difference between an availability of buffer storage at the link partner indicated to the bridge circuitry and an availability of buffer storage indicated to the port controller by the link partner. That is, the reserved type of credit may represent current availability of the N buffer slots reserved (or “stolen”) by the port controller from the total allocation of X buffer slots at the link partner. The port controller may store a counter recording an available number of the N reserved buffer slots, which may be decremented when the particular type of packet is sent, and which may be incremented in response to buffer availability messages from the link partner or in response to completion packets from the link partner. The particular type of packet for which the reserved credits are used is not particularly limited, but in particular may comprise packets generated by the port controller and directed to the link partner (in contrast to packets generated by the bridge circuitry and being forwarded to the link partner, which may be controlled by the bridge circuitry using the first type of credit indicated by the port controller).

In some examples, the bridge circuitry may be configured to communicate with the port controller for communicating external link protocol packets via the external communication link with the link partner, wherein the external link protocol packets are defined according to an external link protocol. The bridge circuitry may hence map between the external link protocol packets defined according to the external link protocol used for the external communication link and memory system interconnect transactions defined according to a memory system interconnect protocol used by a memory system interconnect.

The external link protocol may comprise an input/output (I/O) interface protocol. For example, the external link protocol may be an expansion bus interface which enables connection between a given chip within a host compute system and link partners such as peripheral (I/O) devices or other chiplets of a distributed multi-chip compute system.

For example, the external link protocol may be a PCIe-based protocol, which is derived from the PCIe (Peripheral Component Interconnect Express) standard. For example, the PCIe-based protocol may be PCIe itself, or other related protocols such as CXL (Compute Express Link) which is derived from PCIe.

The external link protocol may comprise a layered protocol, which is based on multiple layers of packet encoding schemes, with one layer encapsulating (e.g. with additional packet headers/footers) a packet defined according to a preceding layer of the protocol. Examples of layered protocols include the PCIe-based protocols mentioned above as well as other protocols such as the AMBAR CHI Chip-to-Chip (C2C) protocol provided by Arm® Limited, which is used for chip-to-chip communication in a multi-chip compute system.

In one particular example, the external link protocol packets may comprise PCIe transaction layer packets. The PCIe specification may also define a data link layer and physical layer, but any packet header/footer associated with these layers may be removed prior to the PCIe transaction layer packets being routed over the internal communication link to the bridge circuitry. Hence, the external link protocol packets may comprise the transaction layer packets as defined by PCIe. It is not necessary for the bridge circuitry to consider encoding/decoding of other PCIe layers such as the data link layer and physical layer.

The port controller may comprise data link layer encoding/decoding circuitry configured to encode/decode PCIe data link layer information for transporting on the external communication link. For example, the PCIe data link layer information could include data link layer packets (DLLPs) and/or data link layer framing information encoded into framing bits around a transaction layer packet (TLP). Hence, the port controller may be the entity that is responsible for encoding and decoding according to the data link layer defined in the PCIe standard. The port controller does not need to be responsible for encoding or decoding according to the transaction layer of PCIe (since it may be the bridge circuitry and the link partner that are respectively responsible for encoding and decoding transaction layer packets). Also, the port controller does not need to be responsible for encoding or decoding a physical layer of the PCIe specification, as this may be done by a separate PHY controller.

In some examples, the bridge circuitry may be configured to use an internal link protocol to transmit packets via the internal communication link, wherein the internal link protocol provides a vessel for transporting the external link protocol packets encapsulated in an internal link protocol packet, without remapping of the external link protocol packets. The internal link protocol may view the external link protocol packets simply as data to be conveyed, without any specific features of the internal link protocol reflecting corresponding features of the external link protocol. Hence, the internal link protocol packets may be seen as “empty vessels” which merely convey the external link protocol packets blindly without any attempt to understand their meaning or remap them to corresponding features of the internal link protocol.

In one particular example, the internal link protocol comprises CXS (the AMBAR CXS, or Credited extensible Stream, streaming interface protocol provided by Arm® Limited). CXS is a protocol-agnostic transport interface that enables multiple external link protocol packets to be transferred per internal link protocol flit over shared wires (e.g. shared between read and write transactions), so can be particularly suited to enabling a reduction in the hardware cost of implementing internal link wiring, while still supporting the high transfer bandwidths required by the latest versions of external link protocols.

However, it will be appreciated that other internal link protocols could also be used. For example, another internal link protocol that could be used may be the Streaming Fabric Interface (SFI) provided by Intel.

Particular examples will now be described with reference to the Figures.

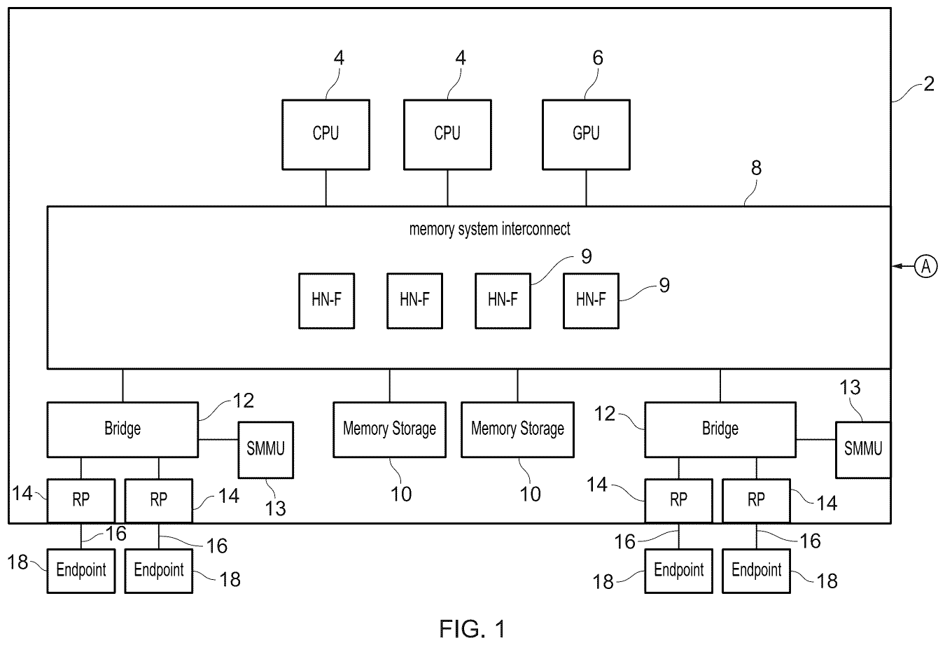

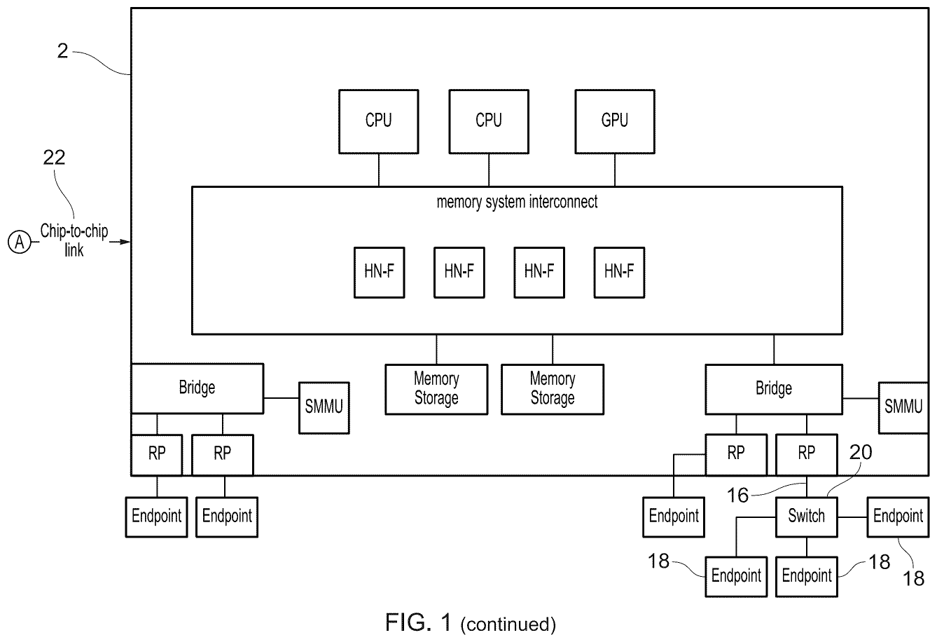

FIG. 1 illustrates an example of a data processing system comprising one or more integrated circuits 2. While FIG. 1 for sake example shows a system with two interconnected integrated circuits (chiplets) 2 connected by a chip-to-chip link 22, other examples of the apparatus 2 may be a system-on-chip implemented on a single integrated circuit 2. Also, while in this particular example, both integrated circuits 2 comprise bridge circuitry and a port controller, it is not essential for every integrated circuit 2 in the system to comprise this circuitry, and some examples could include at least one integrated circuit 2 which does not have such bridge circuitry or port controller at all, or which has bridge circuitry or a port controller that operates in a different manner to that described above.

A given integrated circuit (apparatus) 2 comprises a number of compute circuit units 4, 6, such as one or more central processing units (CPUs) and one or more graphics processing units (GPUs). While FIG. 1 shows an example having two CPUs 4 and one GPU 6 per apparatus 2, other numbers and types of compute units may be provided, and it is not essential for each integrated circuit 2 in a multi-chip compute system to have the same number of compute units.

The compute circuit units 4, 6 share access to a memory system comprising memory storage circuitry 10, which is accessible via a memory system interconnect 8 which may implement a coherent memory system interconnect protocol, such as AMBAR CHI, or a non-coherent memory system interconnect protocol, such as AMBAR AXI. If the memory system interconnect 8 implements a coherent memory system interconnect protocol, then the memory system interconnect may have at least one instance of home node circuitry 9 for implementing coherency enforcement rules to maintain coherency for data cached in the private caches of the compute circuit units 4, 6. For example, the home node circuitry 9 may be responsible for generating, in response to a read/write access to a given address initiated by one requester, snoop requests for snooping nodes which could hold cached data for that address. Any known home node/coherency protocol technique may be used to maintain cache coherency in the system.

The apparatus 2 may have at least one root port 14 acting as an externally facing interface for communication with one or more link partners (generically labelled 18 in subsequent drawings), such as endpoint devices 19 or switches 20. For a given root port 14, the corresponding link partner 19, 20 is located off-chip on a separate integrated circuit from the integrated circuit 2 comprising that root port 14. Communications with the link partner are via an external communication link 16 based on an external link protocol, which may be an I/O protocol such as PCIe, CXL, AMBA@ AXI C2C, etc. The link partner may be any externally located device separate from the integrated circuit 2. For example, examples of link partners may include endpoint devices 19 such as peripherals such as user interface controllers, network interface controllers, controllers for interacting with external memory storage devices, etc. A link partner could also be another system-on-chip similar to the apparatus 2 itself, within a distributed compute system comprising multiple such apparatuses 2 (similar to the relationship between the chiplets 2 connected via the chip-to-chip link 22 as shown in FIG. 1). Some root ports 14 may be coupled via the external communication link 16 to multiple endpoints 19 accessible via a switch 20 (the switch and endpoints not being part of the apparatus 2 itself). Hence, in some cases, the switch 20 acts as the link partner of the root port 14, since the root port 14 has no knowledge of the details of the communication partner device at the other end of the communications link 16.

While FIG. 1 shows an example where the root port circuitry 14 is on the same integrated circuit 2 as other parts of the host apparatus 2 for which it acts as an interface to the external endpoint 18, it is also possible that the root port circuitry 14 could be implemented on a separate chiplet from other parts of its associated host apparatus 2, with a chip-to-chip link 22 between the root port 14 and rest of the host apparatus 2.

The external link protocol used on the external communication link 16 may define read/write transactions in a different manner to the protocol used by the memory system interconnect 8 that links compute circuitry 4, 6 to memory storage 10 within the apparatus 2. Therefore, bridge circuitry 12 may be provided between a root port 14 and the memory system interconnect 8, to map between read/write memory access transactions defined in external link protocol packets on the external communication link 16 and memory system interconnect transactions according to the protocol used on the memory system interconnect 8.

It will be appreciated that FIG. 1 shows just one example arrangement for a processing system, giving an example context in which bridge circuitry 12 may be provided. However, other examples may implement a different configuration of the bridge circuitry 12 relative to other units (e.g. with additional intermediate units between the root port 14 and bridge circuitry 12).

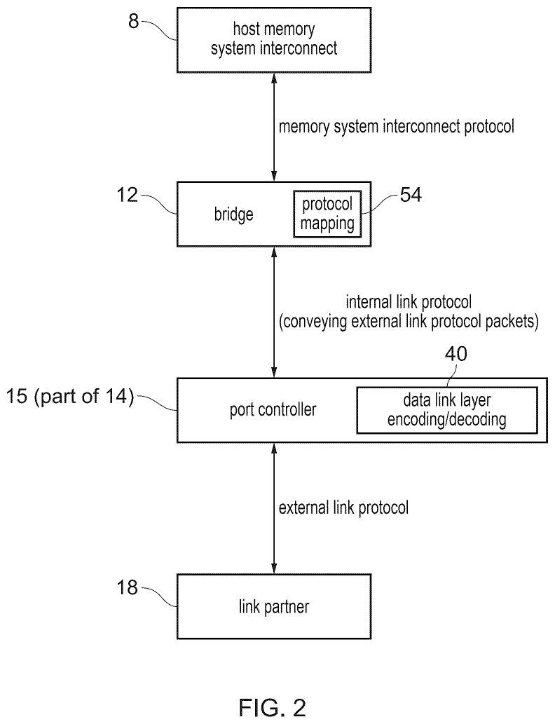

FIG. 2 illustrates an example of different protocols involved in respective communication links in use within the system of integrated circuits 2 shown in FIG. 1. A port controller 15 is provided within the root port 14 for controlling the port at the boundary of apparatus 2 that interfaces with the external communications link 16. The port controller 15 communicates with a link partner 18 (e.g. an endpoint 19 or switch 20) according to an external link protocol, e.g. PCIe or another I/O protocol.

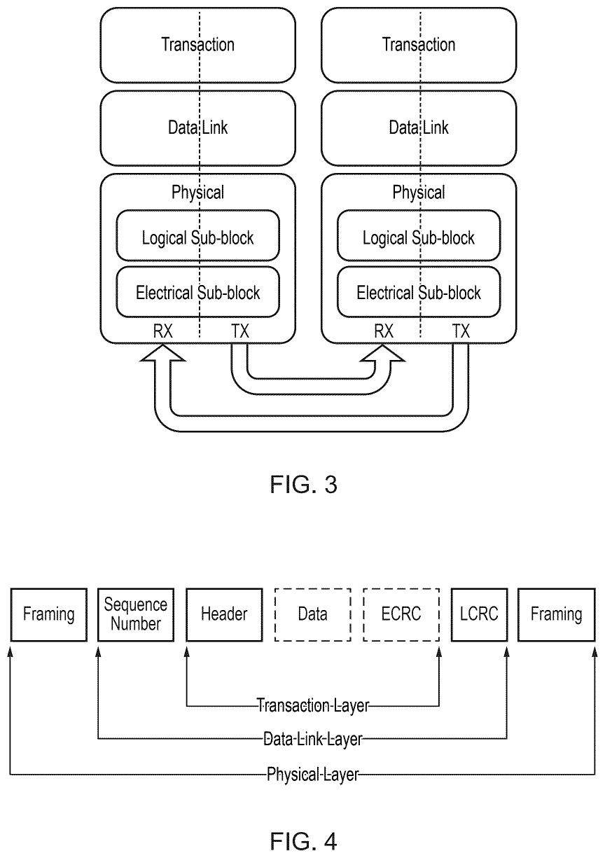

As shown in FIG. 3, the PCIe protocol is a layered protocol which includes a transaction layer, a data link layer and a physical layer.

The transaction layer defines a transaction layer packet format which distinguishes various classes of transactions, including posted transactions (write requests which do not require a completion response), non-posted transactions (read requests or write requests which do require a completion response) and completion transactions (completions sent in response to non-posted read or write requests). The transaction layer packet format has an encoding which differentiates read and write transactions. As shown in FIG. 4, a transaction layer packet may comprise a packet header defining parameters of the transaction, such as transaction type (posted/non-posted/completion, read/write, etc.), a target memory address of the transaction, data payload length, and other attributes (e.g. a relaxed ordering attribute specifying whether a more relaxed ordering model than the stronger default ordering rules is appropriate for this transaction). Optionally, the transaction layer packet includes payload data (e.g. read data for a read transaction response or write data for a write transaction request). Payload data may not be needed for some transactions such as read requests or write completion responses. The transaction layer packet encoding can also optionally include an error correcting code (e.g. end to end cyclic redundancy check, ECRC, code) to protect against transmission errors affecting the transaction layer encoding.

The data link layer is responsible for link management and data integrity, including error detection and error correction, so adds a link layer cyclic redundancy check code (LCRC), in addition to the ECRC if an ECRC is provided by the transaction layer. As shown in FIG. 4, the data link encapsulates the transaction layer packet using framing information specifying a sequence number and the LCRC. The data link layer may also provide data link layer packets DLLPs) which are separate from the transaction layer packets and are communicated over the external communication link.

The Physical Layer specifies circuitry required for physical interface operation, including driver and input buffers, parallel-to-serial and serial-to-parallel conversion, phase locked loops (PLLs), and impedance matching circuitry. The physical layer circuitry adds framing symbols to the transmitted packets, which enable a receiver to detect the start and end of packets.

Hence, there may be a number of layers of encoding/decoding applied at the interfaces to the external communication link. Referring again to FIG. 2, responsibility for encoding/decoding the transaction layer packet data may lie with the bridge circuitry 12 and link partner 18 respectively (although the port controller 15 could optionally have some circuitry for checking that transaction layer packets are correctly formed). More particularly, within the bridge circuitry 12, protocol mapping circuitry 54 may be provided to map between the transaction layer packets of the external link protocol and the memory system interconnect transactions of the memory system interconnect protocol. Responsibility for encoding/decoding the data link layer packet data lies with the link partner 18 and data link layer encoding/decoding circuitry 40 implemented at the port controller 15 within the root port 14. Responsibility for encoding/decoding the physical layer packet data lies with the link partner 18 and a PHY controller (not shown in FIG. 2) that is implemented within the root port 14.

Hence, for inbound transactions received from the link partner 18 requesting access to the host memory system 10 of the apparatus, the protocol mapping steps are as follows:
the link partner 18 (or an endpoint device that is in communication with the link partner 18) generates the transaction/data link/physical layer packet encoding according to the external link protocol, and the link partner 18 transmits the encoded packets across the external communication link 16;
a PHY controller (not shown in FIG. 2) decodes the physical layer of the transmitted packets;
data link layer decoding circuitry 40 within the port controller 15 decodes data link layer packets, and decodes/removes any data link layer framing information from transaction layer packets defined according to the external link protocol;
the port controller 15 transmits the transaction layer packets to the bridge circuitry 12 as payload data transmitted within an internal link protocol used for an internal communication link 70 between the bridge 12 and the port controller 15;
the bridge circuitry 12 decodes the transaction layer packets (defined according to the external link protocol but transported as payload data in at least one flit transmitted according to the internal link protocol), and uses its protocol mapping circuitry 54 to map any read/write requests or other transactions defined in those packets to corresponding transactions defined according to the memory system interconnect protocol, which are forwarded to the memory system interconnect 8 for servicing by the host's memory system.

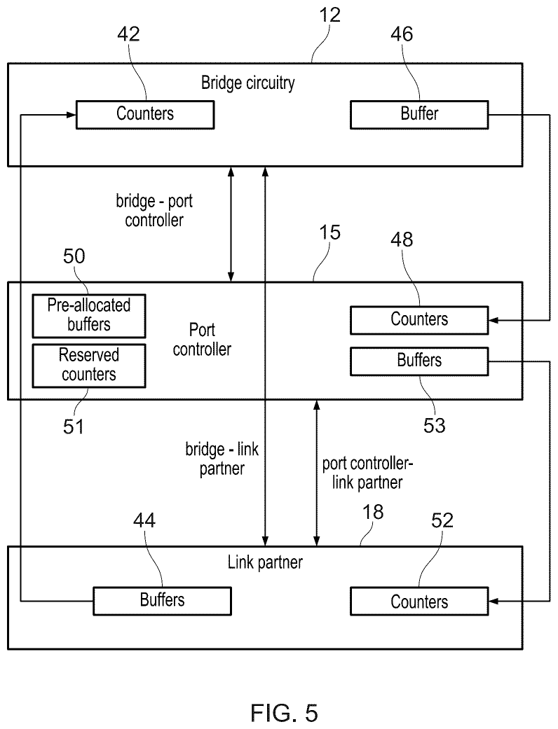

On the other hand, for outbound transactions to be transmitted to a link partner 18, e.g. generated based on memory system interconnect transactions to addresses mapped to the root port 14, the protocol mapping steps are as follows:
in response to receipt of a transaction from the memory system interconnect 8 (defined according to the memory system interconnect protocol), the protocol mapping circuitry 54 at the bridge circuitry 12 generates corresponding transaction layer packets according to the external link protocol used on the external communication link 16 (e.g. with read/write transactions mapped to corresponding encodings of read/write transactions in the external link protocol);
the bridge circuitry 12 transmits the external link protocol transaction layer packets on the internal communication link 70, as payload data accompanied by control information defined according to the internal link protocol;
the port controller 15 extracts the transaction layer packets from the payload data conveyed on the internal communication link, and uses its data link layer encoding/decoding circuitry 40 to append data link layer encoded framing information (e.g. the sequence number and LCRC as shown in FIG. 4) to the transaction layer packets. The external port controller 15 may also be responsible for generation of any data link layer packets (DLLPs);
the PHY controller of the root port 14 encodes the physical layer of the external link protocol packets (as a wrapper around the framed transaction layer packet generated by data link layer encoding/decoding circuitry 40), and transmits the physical layer packets on the external communication link 16 to the link partner 18.
Exchange of external link protocol packets between the bridge circuitry 12 and the link partner 18 uses a first type of credit (e.g., a PCIe credit). The first type of credit represents buffer availability at a receiver and may be used to ensure that a transmitter does not send more packets than can be handled by the receiver. FIG. 5 illustrates the use of the first type of credit.

On the inbound path from a link partner 18 to bridge circuitry 12, the connection between the link partner 18 and port controller 15 (over the external communication link) is credited separately to the communication link between the port controller 15 and the bridge circuitry 12. The port controller 15 comprises buffers 53 for receiving packets from the link partner 18, and provides credit exchange messages (via the external communication link) indicating availability of the buffers 53 to the link partner 18. The link partner 18 comprises counters 52 tracking availability of the buffers 53 and updated in response to the credit exchange messages sent by the port controller 15.

Similarly, the bridge circuitry 12 comprises buffers 46 for receiving packets form the port controller 15, and provides credit exchange messages (via a side band of the internal communication link) indicating availability of the buffers 46 to the port controller 15. These credits exchanged between the port controller 15 and bridge circuitry 12 may be referred to as application layer credits. The port controller 15 provides counters 48 tracking availability of the buffers 46 which are updated in response to the credit exchange messages sent by the bridge circuitry 12.

For an inbound message to be received, the counters 52 at the link partner must indicate that the port controller 15 has available buffer capacity. An external link protocol packet may then be issued to the port controller 15 and the counters 52 decremented. The external link protocol packet may then be received by the port controller 15 and buffered in buffers 53. The external link protocol packet may then be handled as discussed above and transmitted to the bridge circuitry 12 as long as the counters 48 indicate that the buffers 46 at the bridge circuitry have available capacity. If the packet is transmitted to the bridge circuitry, the counters 48 are decremented to indicate reduced availability in the buffers 46. In response to transmitting the packet to the bridge circuitry 12, the port controller 15 may issue a credit exchange message to the link partner 18 indicating that the buffer space in buffers 53 occupied by that packet is now available, and the link partner 18 may increments the counters 52 as appropriate.

The outbound path, concerning packets transmitted from the bridge circuitry 12 to the link partner 18 is handled differently. Rather than advertising the credits of the port controller buffers 15 to the bridge circuitry 12, the port controller 15 advertises to the bridge circuitry 12 credits representing buffer availability at the link partner 18. Hence, a set of counters 42 at the bridge circuitry track availability of buffers 44 at the link partner. This means that the port controller 15 can avoid implementing intermediary buffering, by passing the link partner credits to the bridge circuitry.

The link partner provides credits to the port controller 15, and the port controller can choose to either pass the same message through to the bridge circuitry, or send a different type of credit exchange message to the bridge circuitry 12 to pass the credits through to the bridge circuitry 12. The port controller 15 may also maintain a set of counters tracking the availability of buffers 44 at the link partner which may be updated by messages from the link partner 18 and used to generate credit exchange messages to update the counters 42 of the bridge circuitry 12. The link partner may provide credits to the port controller 15 using a lossy protocol (e.g., the UpdateFc mechanism in the PCIe specification), and the port controller 15 can choose to maintain the same behavior for communicating the application layer credits to the bridge circuitry 12, or convert the lossy protocol to a lossless protocol.

For both the inbound and outbound paths, packets may be credited per packet type. Hence, a separate set of buffers and counters may be maintained for each of posted, non-posted, and completion packet types. The manner of exchanging credits may however be the same for each packet type.

In the manner described above, a logical connection is provided between the bridge circuitry 12 and the link partner 18 via the port controller 15, in which the bridge circuitry 12 and the link partner 18 exchange transaction layer packets of the external link protocol. As illustrated in FIG. 5, logical connections are also provided between the bridge circuitry 12 and port controller 15 and between the port controller 15 and the link partner 18.

In the inbound direction, communication between the link partner 18 and port controller 15, and between the port controller 15 and the bridge circuitry 12 may be handled using the first type of credit, in the same way as packets from the link partner 18 to the bridge circuitry 12. This is possible as separate credit schemes are provided for each connection.

In the outbound direction, communication of packets from the bridge circuitry 12 terminating at the port controller 15 is credited using a separate scheme from the first type of credit (which do not represent buffer availability at the port controller 15, and hence cannot be used for direct communication from the bridge circuitry terminating at the port controller). The port controller provides a pre-allocated amount of buffer storage 50, the initial amount of which is known to the bridge circuitry 12. The bridge circuitry maintains a count (e.g., in the counters 42) of a number of the pre-allocated buffer slots currently available (referred to elsewhere as a second type of credit). When the bridge circuitry transmits a packet targeting the port controller 15 (rather than the link partner 18) the number of the second type of credit is decremented (and the first type of credit is not used). The port controller 15 does not provide sideband credit exchange messages indicating availability of the second type of credit. Instead, the port controller 15 provides a completion packet in response to a packet from the bridge circuitry 12, and receipt of the completion packet at the bridge circuitry indicates to the bridge circuitry 12 that a packet previously buffered by the port controller 15 has now been handled and hence the bridge circuitry may increment an available number of the second type of credit. Hence, the second type of credit may represent outstanding transactions from the bridge circuitry to the port controller, and can be controlled based on the exchange of packets to and from the port controller. The second type of credit may only be used for non-posted packets for which a completion response is requested (to enable completion packets to be used to manage availability of the second type of credit). The second type of credit may be used for communication between the bridge circuitry and the port controller even when the external communication link between the port controller and link partner is unavailable (and, when this link is unavailable, may be used to handle certain packets from the bridge circuitry to the link partner which require a response, as discussed below).

As with the first type of credit, the second type of credit may be tracked separately for different packet types (and hence there may be a number of pre-allocated buffer slots at the port controller 15 for each of posted, non-posted, and completion packets).

In the outbound direction, communication of packets from the port controller 15 to the link partner 18 may be handled using the first type of credit. However, to ensure that there are available credits for this link (and that the credits are not all used by the bridge circuitry), the port controller 15 may set aside a number of credits communicated from the link partner 18. That is, the link partner 18 may indicate X credits to the port controller 15 representing X available buffer slots in the buffers 44. The port controller 15 may provide a credit exchange message to the bridge circuitry 12 indicating that there are X-N buffer slots available in the buffers 44, and hence reserving N buffer slots for packets originating at the port controller 15 and directed to the link partner 18 (it is noted that this message is based on X and hence still provides an indication of buffer availability at the link partner 18). The port controller 15 may for example provide counters 51 indicating an available number of the reserved credits, which may be maintained in a similar way to the way in which the first type of credit is maintained at the bridge circuitry 12.

Although not shown in FIG. 5, the inbound path may also implement pre-allocated buffers provided at the bridge circuitry 12 and used for communication from the port controller 15 to the bridge circuitry 21 without using the first type of credit.

The connections between the bridge circuitry 12 and the port controller 15 are managed according to an application layer protocol. Application layer functionality may be implemented in the bridge circuitry and the port controller, and the intermediary network layer between the bridge circuitry and the port controller is not aware of the application layer functionality. The application layer functionality includes credit management for packets exchanged between the bridge circuitry and the port controller, maintenance of the application later states, sinking and sourcing of application layer messages (including error messages, credit exchange, and configuration register accesses), CXS packetization, and PCIe packet formation. In the bridge circuitry, the application layer functionality maps to a target port controller from an address specified in an outbound packet, and tracks outstanding inbound requests to correctly identify the corresponding port controller to respond to. In the port controller, the application layer functionality maintains “PCIe to application layer” tag mapping for inbound requests.

An application layer connection between the bridge circuitry 12 and port controller 15 is unidirectional, with one side acting as a transmitter and one side acting as a receiver. Hence, the bridge circuitry 12 and port controller 15 maintain two application layer connections, one for inbound traffic and one for outbound traffic. The application layer may control exchange of messages over two bands. Packets (e.g., transaction layer packets) may be sent via a mainband interface (e.g., CXS), while application layer messages (e.g., credit exchange, application state transition messages) may be sent via a sideband interface (e.g., CXS-lite).

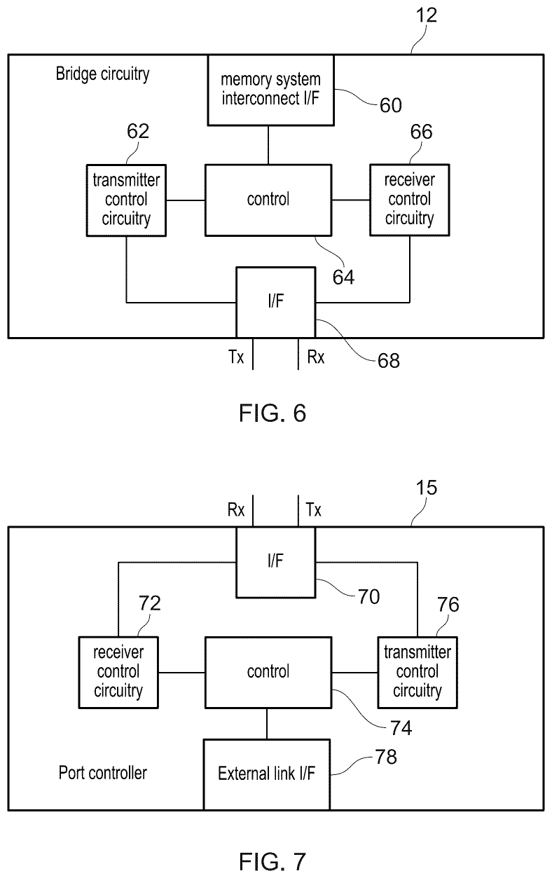

FIGS. 6 and 7 illustrate the bridge circuitry 12 and the port controller 15 in further detail, indicating the transmitter and receiver provided in each of the bridge circuitry and port controller to facilitate application layer connections.

The bridge circuitry 12 includes a memory system interconnect interface 60 for transmitting and receiving memory system interconnect protocol messages to/from the memory system interconnect 8, and control circuitry 64 for instance comprising the protocol mapping circuitry 54 described earlier for mapping between the memory system interconnect protocol messages and the transaction layer packets according to the external link protocol used by the external communication link 16. The bridge circuitry also includes transmitter control circuitry 62 and receiver control circuitry 66. The transmitter control circuitry 62 and receiver control circuitry 66 are coupled to an internal link interface 68 for controlling communication of information on the internal communication link, according to the internal link protocol (e.g. CXS and CXS-lite) used on that link.

The port controller 15 includes an external link interface 78 for transmitting and receiving external link protocol messages to/from the link partner 18, and control circuitry 74 for instance comprising the data link layer encoding/decoding circuitry 40 described earlier. The port controller also includes receiver control circuitry 72 and transmitter control circuitry 76. The transmitter control circuitry 76 and receiver control circuitry 72 are coupled to an internal link interface 70 for controlling communication of information on the internal communication link, according to the internal link protocol (e.g. CXS and CXS-lite) used on that link.

The transmitter control circuitry 62, 76 controls the transmitter side of each application layer connection, and the receiver control circuitry 66, 72 controls the receiver side of each application layer connection.

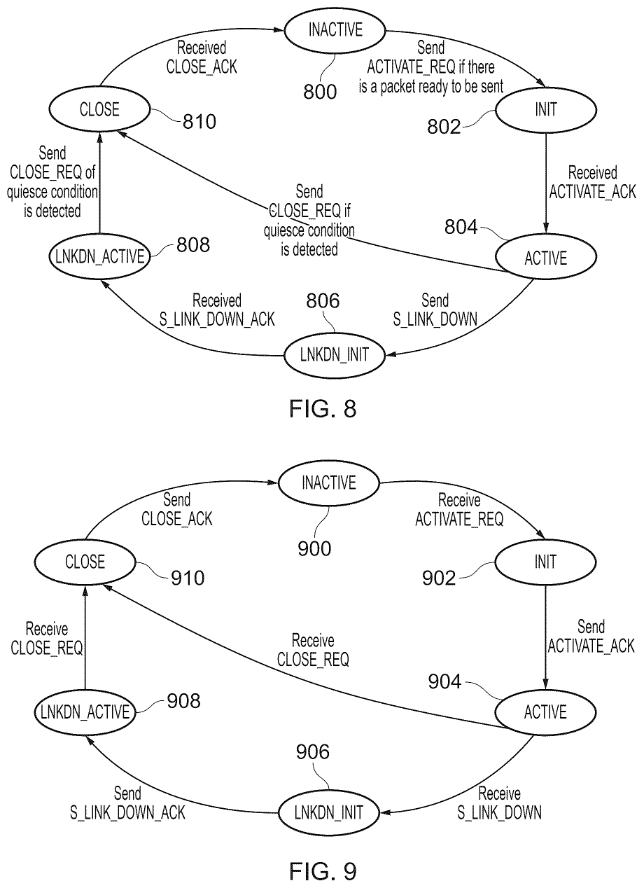

FIG. 8 is a state diagram illustrating a number of states which may be taken by the transmitter control circuitry 62, 76 and the transitions between those states. FIG. 9 is a state diagram illustrating a number of states which may be taken by the receiver control circuitry 66, 72 and the transitions between those states.

The states of the transmitter are linked to the states of the receiver. A request for a change of state may be triggered by the transmitter by sending an application layer control message to the receiver (as discussed below).

As illustrated in FIG. 8, the transmitter (e.g., the bridge circuitry 12) has an INACTIVE state 800. The transmitter may enter the INACTIVE state 800 out of reset (not shown in FIG. 8), or in response to receiving a CLOSE_ACK message. In the INACTIVE state 800, the transmitter cannot receive credits from the receiver and packets cannot be sent to the receiver.

The transmitter transitions from the INACTIVE state 800 to an INIT state 802 in response to sending an ACTIVATE_REQ message (an application layer control message) to the receiver. The ACTIVATE_REQ message may be sent in response to the transmitter control circuitry determining that there is a packet ready to be sent to the receiver. In the INIT state 802, the transmitter cannot send packets or receive credits, and the transmitter is awaiting acknowledgement from the receiver that the receiver is ready to receive the packet.

The transmitter transitions from the INIT state 802 to an ACTIVE state 804 (referred to elsewhere in one example as the first state of the bridge circuitry) in response to receiving an ACTIVATE_ACK message from the receiver. In the ACTIVE state 804, the transmitter may send transaction layer packets (TLPs, e.g., according to the PCIe protocol) to the receiver using credits provided from the receiver (the first type of credit, as discussed above). The transmitter may receive credits from the receiver via application layer control messages. In the ACTIVE state 804, the transmitter may also send TLPs using the second type of credit representing pre-allocated buffer space in the receiver. For instance, the transmitter may use the second type of credit for non-posted TLPs targeting the receiver (rather than a link partner beyond the receiver). Hence, in the ACTIVE state 804 there is an ongoing exchange of packets and credits. For example, when the transmitter is provided by the bridge circuitry 12 and the receiver provided by the port controller 15, the ACTIVE state may allow exchange of packets between the bridge circuitry 12 and the link partner 18 using credits representing buffer availability at the link partner 18.

The transmitter transitions from the ACTIVE state 804 to a LNKDN_INIT state 806 in response to sending an S_LINK_DOWN message to the receiver. The S_LINK_DOWN message is triggered by an unmanaged link down event being communicated to the transmitter. The unmanaged link down event indicates that the link between the port controller 15 and the link partner 18 is unavailable, and hence credits cannot be communicated from the link partner to the port controller and packets cannot be communicated from the port controller to the link partner. The LNKDN_INIT state is a transient state, and in the LNKDN_INIT state no packets may be sent, although credits may be received.

The transmitter may also transition from the ACTIVE state 804 to a CLOSE state 810 in response to sending a CLOSE_REQ message. The trigger for initiating a CLOSE_REQ message is complete draining of the transmit queues, indicating that there are no pending packets for transmission. The CLOSE state 810 is discussed below.

The transmitter transitions from the LNKDN_INIT state 806 to the LNKDN_ACTIVE state 808 (referred to elsewhere in one example as the second state of the bridge circuitry) in response to receiving an S_LINK_DOWN_ACK message from the receiver. The LNKDN_ACTIVE (link down active) state allows the bridge circuitry 12 to handle an unmanaged link down event gracefully. Without the link down active state, when the external communication link is unavailable the transmitter would have to transition into the INACTIVE state as credits are unavailable. This would leave buffers at the transmitter full, and would leave the transmitter unable to communicate with the receiver. The link down active state however allows a communication link to be maintained even without the first type of credit being available.

In the LNKDN_ACTIVE state 808, the transmitter may drain transmit queues. Posted and completion packets may be sent to the receiver without using any credits. Non-posted packets (for which a response is expected) may be sent using pre-allocated credits (the second type of credit discussed above), to ensure there is sufficient buffer capacity at the receiver to receive these messages (and hence allow a response to be generated). Non-posted packets may be sent using the second type of credit in the LNKDN_ACTIVE state 808 regardless of whether those packets target the receiver (e.g., the port controller 15) or another entity (e.g., the link partner 18). The transmitter is unable to receive credits in the LNKDN_ACTIVE state 808. The transmitter increments a counter tracking the second type of credit in response to a completion response from the receiver corresponding to a non-posted packet sent using the second type of credit.

The transmitter transitions from the LNKDN_ACTIVE state 808 to the CLOSE state 810 in response to sending a CLOSE_REQ message. The trigger for initiating a CLOSE_REQ message is complete draining of the transmit queues, indicating that there are no pending packets for transmission.

The CLOSE state 810 is a transient state leading into the INACTIVE state 800. In the CLOSE state 810, packets cannot be sent, credits cannot be received, and credit counters are reset. The transmitter transitions from the CLOSE state 810 to the INACTIVE state 800 in response to receiving a CLOSE_ACK message from the receiver.

As illustrated in FIG. 9, the receiver (e.g., the port controller 15) has an INACTIVE state 900. The receiver may enter the INACTIVE state 900 out of reset, or in response to sending a CLOSE_ACK message. In the INACTIVE state 900, the receiver cannot send credits to the transmitter and packets cannot be received from the transmitter. In the INACTIVE state 900, the receiver has all of the first type of credit.

The receiver transitions from the INACTIVE state 900 to an INIT state 902 in response to receipt of an ACTIVATE_REQ message (an application layer control message) from the transmitter. In the INIT state 902, the receiver cannot receive packets or grant credits. The INIT state 902 is a transient state before the receiver enters the ACTIVE state 904.

The receiver transitions from the INIT state 902 to an ACTIVE state 904 (referred to elsewhere in one example as the first state of the port controller) in response to sending an ACTIVATE_ACK message to the transmitter. In the ACTIVE state 904, the receiver may receive transaction layer packets (TLPs, e.g., according to the PCIe protocol) from the transmitter, and may grant credits to the transmitter (the first type of credit, as discussed above, which may have previously been received from a link partner). In the ACTIVE state 904, the receiver may also receive TLPs using pre-allocated buffer space. Hence, in the ACTIVE state 904 there is an ongoing exchange of packets and credits. For example, when the transmitter is provided by the bridge circuitry 12 and the receiver provided by the port controller 15, the ACTIVE state may allow exchange of packets between the bridge circuitry 12 and the link partner 18 using credits representing buffer availability at the link partner 18.

The receiver transitions from the ACTIVE state 904 to a LNKDN_INIT state 906 in response to receiving an S_LINK_DOWN message from the transmitter. The LNKDN_INIT state is a transient state, and in the LNKDN_INIT state packets may be received and credits may be sent. In particular, in the LNKDN_INIT state 904, packets sent by the transmitter (on the mainband interface) before the S_LINK_DOWN message was sent (on the sideband interface) may be received after the S_LINK_DOWN message has been received, although this is transient and no packets may be sent by the transmitter after issuing the S_LINK_DOWN message.

The receiver may also transition from the ACTIVE state 904 to a CLOSE state 910 in response to receiving a CLOSE_REQ message. The CLOSE state 910 is discussed below.

The receiver transitions from the LNKDN_INIT state 906 to the LNKDN_ACTIVE state 908 (referred to elsewhere in one example as the second state of the port controller) in response to sending an S_LINK_DOWN_ACK message to the transmitter. In the LNKDN_ACTIVE state 908, the receiver accepts and drops (e.g., without buffering) posted and completion TLPs from the transmitter. The receiver accepts non-posted TLPs and generates a completion response (e.g., both for TLPs targeting a link partner and for TLPs targeting the receiver itself). The receiver does not send credits in the LNKDN_ACTIVE state 908.

The receiver transitions from the LNKDN_ACTIVE state 908 to the CLOSE state 910 in response to receiving a CLOSE_REQ message. The CLOSE state 910 is a transient state leading into the INACTIVE state 900. In the CLOSE state 910, packets cannot be received and credits cannot be sent. The receiver transitions from the CLOSE state 910 to the INACTIVE state 900 in response to sending a CLOSE_ACK message.

As illustrated in FIGS. 6 and 7, each of the bridge circuitry 12 and port controller 15 may act as both a receiver and a transmitter for separate application layer connections. If the transmitter for one of the connections initiates an S_LINK_DOWN message, the transmitter of the other connection should also initiate the S_LINK_DOWN message. If the transmitter of one of the connections initiates a CLOSE_REQ message, the transmitter of the other connection should also initiate a CLOSE_REQ message. Hence, the states of the transmitter and receiver of the bridge circuitry 12 are linked, as are the states of the transmitter and receiver of the port controller 15.

The INIT states 802, 902, LNKDN_INIT states 806, 906, and the CLOSE states 810, 910 are intended to be transient states leading to the ACTIVE states 804, 904, LNKDN_ACTIVE states 808, 908, and INACTIVE states 800, 900 respectively. However, there may be no limit set on the duration of those transient states.

In principle, the transmitter in the bridge circuitry 12 and the transmitter in the port controller 15 may both be controlled according to the state diagram shown in FIG. 8, and the receiver in the bridge circuitry 12 and the receiver in the port controller 15 may both be controlled according to the state diagram shown in FIG. 9. However, the six-state state machine shown in FIGS. 8 and 9 may be particularly useful for supporting communication (using the LNKDN_ACTIVE states) when the first type of credit is unavailable, which may in some cases primarily be relevant for the outbound application layer connection (where the credits originate from the link partner 18, the link to which might be unavailable while the internal communication link is still available). Hence, in some examples the transmitter in the bridge circuitry 12 may be controlled according to the state diagram shown in FIG. 8 whilst the transmitter in the port controller 15 may be controlled differently (e.g., according to a state diagram excluding the LNKDN_INIT and LNKDN_ACTIVE states), and likewise the receiver in the port controller 15 may be controlled according to the state diagram shown in FIG. 9 whilst the receiver in the bridge circuitry 12 may be controlled differently (e.g., according to a state diagram excluding the LNKDN_INIT and LNKDN_ACTIVE states).

In an example use case, a transmitter 76 and receiver 72 provided by the port controller 15 are in the ACTIVE states 804, 904 when the external communication link becomes unavailable. The transmitter 76 provided by the port controller 15 sends the S_LINK_DOWN message to the receiver 66 provided by the bridge circuitry. This causes the transmitter 62 provided by the bridge circuitry to send the S_LINK_DOWN message to the receiver 72 provided by the port controller 15. Hence, all four state machines forming the application layer connection between the bridge circuitry 12 and the port controller 15 can be caused to enter the LNKDN_INIT and ultimately LNKDN_ACTIVE states. This allows both the bridge circuitry 12 and port controller 15 to drain their transmit queues. For the port controller 15 no further traffic is expected from the link partner 18 since the external communication link is down. For the bridge circuitry, further packets could in principle be received from the memory system interconnect interface 60, and hence the bridge circuitry 12 may send an interrupt over the memory system interconnect interface 60 to software when it receives the S_LINK_DOWN message. The software may, for instance, indicate to the bridge circuitry (e.g., by setting a field in the bridge register space) when no further packets are expected, after which the bridge may drain its transmit queues and issue a flushing non-posted request. When the completion response is received from the port controller 15 for the flushing non-posted request, this indicates that all outstanding transactions have been handled and hence the transmitter 62 provided by the bridge circuitry 12 may issue the CLOSE_REQ message, causing the transmitter 76 provided by the port controller 15 to also issue the CLOSE_REQ message, and ultimately causing both transmitter and receiver on both sides of the application layer communication link to enter the INACTIVE states.

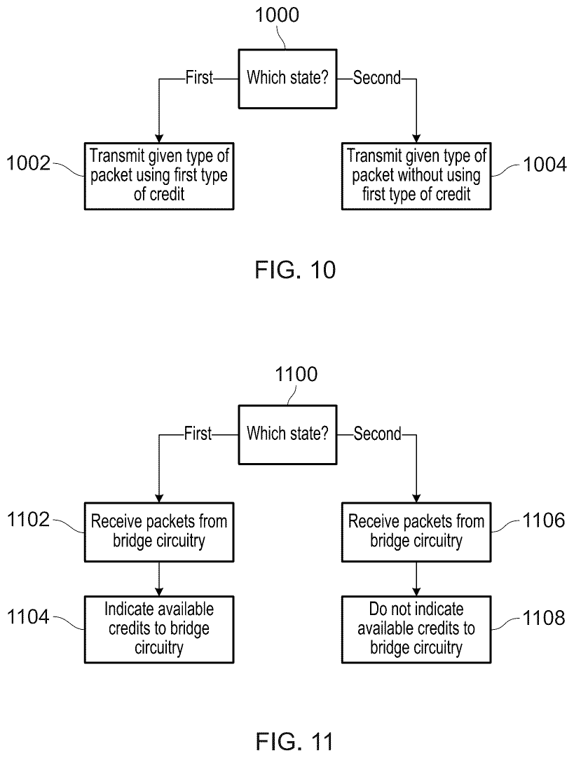

FIG. 10 is a flow diagram illustrating a method performed by bridge circuitry 12 for communicating with a port controller 15. At step 1000 the bridge circuitry determines whether it is in a first state or a second state. If the bridge circuitry is in the first state (e.g., the ACTIVE state of FIG. 8) then at step 1002 the bridge circuitry is configured to transmit a given type of packet (e.g., posted, non-posted, or completion packets targeting the link partner 18) using a first type of credit communicated from the link partner 18. If the bridge circuitry is in the second state (e.g., the LNKDN_ACTIVE state of FIG. 8) then at step 1004 the bridge circuitry is configured to transmit the given type of packet without using the first type of credit. The given type of packet may be transmitted using no credits (e.g., if it is a posted or completion packet) or may be transmitted using a second type of credit (e.g., representing pre-allocated buffer storage at the port controller 15).

FIG. 11 is a flow diagram illustrating a method performed by a port controller 15 for communicating with bridge circuitry 12. At step 1100 the port controller determines whether it is in a first state or a second state. If the port controller is in the first state (e.g., the ACTIVE state of FIG. 9), then the port controller is configured to receive packets from the bridge circuitry at step 1102, and indicate availability of a first type of credit (e.g., representing buffer availability at a link partner) to the bridge circuitry at step 1104. If the port controller is in the second state (e.g., the LNKDN_ACTIVE state of FIG. 9), then the port controller is configured to receive packets from the bridge circuitry at step 1106, but at step 1108 does not indicate availability of the first type of credit to the bridge circuitry.

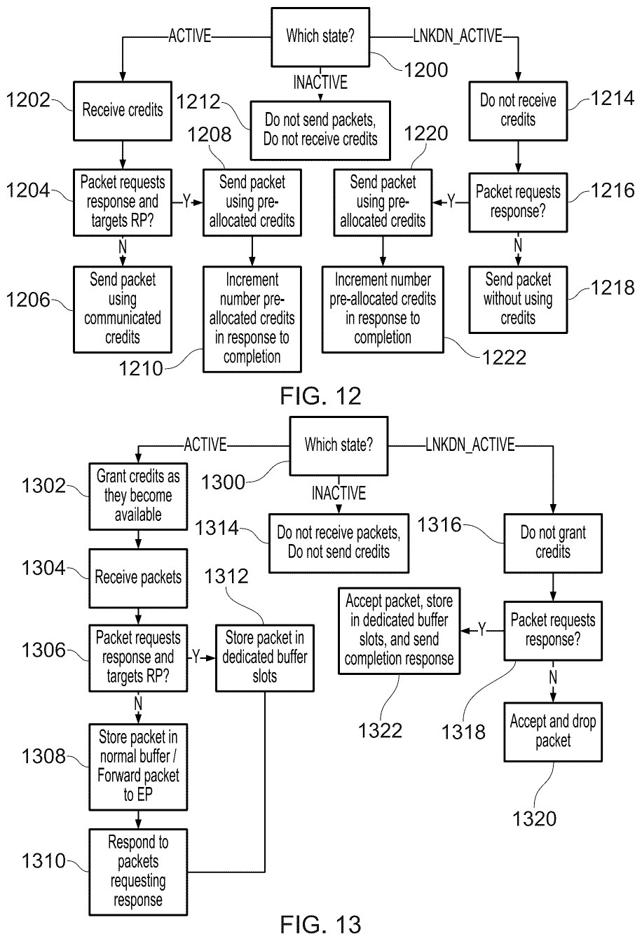

FIG. 12 is a flow diagram illustrating a method performed by a transmitter, such as the bridge circuitry. At step 1200 the transmitter determines whether it is in an ACTIVE state, an INACTIVE state, or a LNKDN_ACTIVE state (as illustrated in FIG. 8).

If the transmitter is in the ACTIVE state, then at step 1202 the transmitter receives credits from a receiver via a sideband communication path (e.g., CXS-lite). At step 1204 the transmitter determines if a given packet requests a response (e.g., whether the packet is a non-posted packet) and targets the port controller. If so, the transmitter sends the packet using pre-allocated credits at step 1208 (separate from the credits received at step 1202). In due course, the transmitter increments the available number of pre-allocated credits at step 1210 in response to receiving a completion packet from the receiver in response to a packet sent using the pre-allocated credits. If the packet did not request a response from the port controller, at step 1206 the transmitter sends the packet using the credits received at step 1202.

If the transmitter is in the INACTIVE state, then at step 1212 the transmitter does not send packets, and does not receive credits from the receiver.

If the transmitter is in the LNKDN_ACTIVE state, then at step 1214 the transmitter does not receive credits from the receiver via the sideband path. At step 1216 the transmitter determines if a given packet requests a response (with or without targeting the port controller). If so, then at step 1220 the packet is sent using pre-allocated credits. In due course, the transmitter increments the available number of pre-allocated credits at step 1222 in response to receiving a completion packet from the receiver in response to a packet sent using the pre-allocated credits. If the packet did not request a response, at step 1218 the transmitter sends the packet without using any credits.

FIG. 13 is a flow diagram illustrating a method performed by a receiver, such as the port controller. At step 1300 the receiver determines whether it is in an ACTIVE state, an INACTIVE state, or a LNKDN_ACTIVE state (as illustrated in FIG. 9).

If the receiver is in the ACTIVE state, then at step 1302 the receiver provides credits to a transmitter via a sideband communication path (e.g., CXS-lite). At step 1304 the receiver receives packets from the transmitter. At step 1306 the receiver determines if a given packet requests a response (e.g., whether the packet is a non-posted packet) and targets the port controller. If so, the receiver stores the packet in dedicated buffer storage without reducing an available number of the credits granted in step 1302. If the packet did not request a response from the port controller, at step 1308 the receiver stores the packet in a buffer slot reducing the number of available credits (if provided in the bridge circuitry), or forwards the packet to a link partner without buffering (if provided in the port controller).

If the receiver is in the INACTIVE state, then at step 1314 the receiver does not send credits, and does not receive packets from the transmitter.

If the receiver is in the LNKDN_ACTIVE state, then at step 1316 the receiver does not grant credits to the transmitter via the sideband path. At step 1318 the receiver determines if a given packet requests a response (with or without targeting the port controller). If so, then at step 1322 the packet is accepted, stored using the dedicated buffer slots, and a completion response is generated and sent to the transmitter. If not, then at step 1320 the packet is accepted and dropped by the receiver.

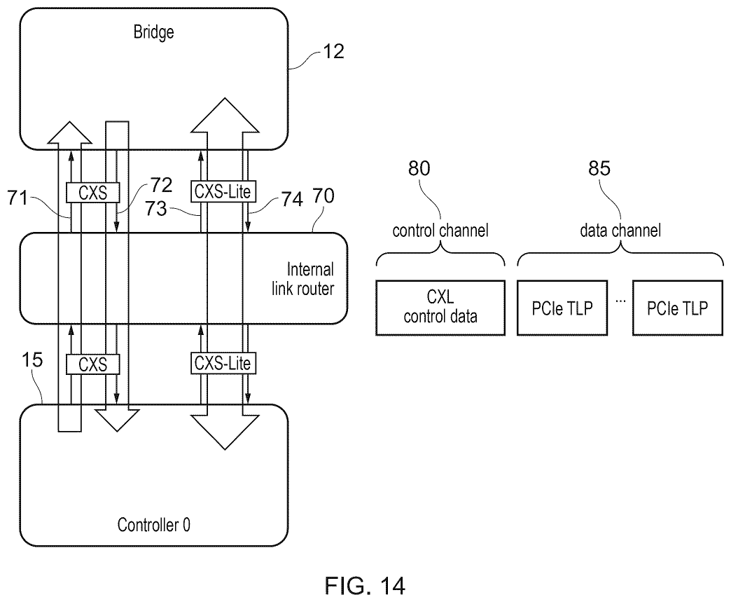

FIG. 14 illustrates in more detail an example implementation of channels of communication on the internal communication link 70. The CXS protocol is a unidirectional protocol, so for bidirectional communication, at least two separate CXS channels would be used:
an inbound channel 71 for inbound transactions from external port controller 15 to bridge 12, and an outbound channel 72 for outbound transactions from bridge 12 to external port controller 15. The main inbound/outbound CXS channels 71, 72 can have variable data width depending on the desired bandwidth to be supported. Additional inbound and outbound CXS channels 73, 74 are provided, denoted as “CXS-Lite” which may have narrower datapaths than the main channels 71, 72. The CXS Lite channels 73, 74 are used for sideband messages such as shadow configuration writes, error messages, connection management and flow control messages. By providing a separate sideband channel 73, 74 from the main channel 71, 72 used for routing the external link protocol packets themselves, this prevents control messages delaying the transmission of the external link protocol packets, to improve throughput of the external link transactions.

As shown in FIG. 14, for each CXS channel 71-74 (including the main band channels 71, 72 or the sideband channels 73, 74), that channel comprises a control channel 80 and a data channel 85, with the data channel 85 transporting the transaction layer packets of the PCIe or other external link protocol as data payload, accompanied by control data on the control channel which is defined according to the CXL protocol, and is encoded to denote information such as packet size or packet start/end of packets encoded on the data channel 85.

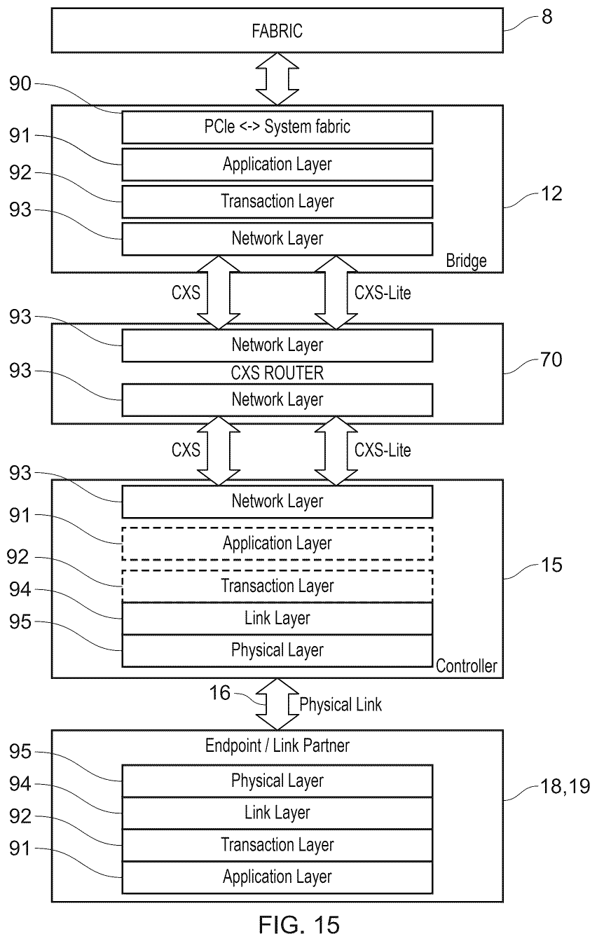

As shown in FIG. 15, with the use of CXS as the internal link protocol on the internal communication link 70, a number of layers of encoding/decoding are involved in a system comprising the integrated circuit (apparatus) 2 and link partner 18 (e.g. endpoint 19). The layers include:
a system fabric protocol encoding/decoding layer 90, implemented by the protocol mapping circuitry 54 at the bridge circuitry 52 (although not shown in FIG. 15, the memory system interconnect 8 and/or other system components 4, 6, 10 of the host system may have similar system fabric protocol encoding/decoding layer for encoding/decoding according to the memory system interconnect protocol);
an application layer 91, implemented using encoding/decoding circuitry at the bridge circuitry 91 and the link partner 18 (or at an endpoint 19 which communicates with the link partner 18). The application layer 91 is outside the scope of what is defined in the PCIe specification, but may define information to be included as payload data within a transaction layer packet. For example, the application layer may implement additional networking protocols. Although the application layer encoding and decoding may be applied at the link partner/endpoint end for inbound and outbound transactions respectively, the external port controller 15 could also include application layer circuitry for updating or verifying application layer encoded payload data within a PCIe transaction layer packet.
the transaction layer 92 defined according to PCIe (external link protocol), which is encoded/decoded using the protocol mapping circuitry 54 at the bridge circuitry 12 and corresponding encoding/decoding circuitry at the link partner 18 (or at an endpoint 19 which communicates with the link partner 18). Although the link partner 18 or endpoint 19 encodes inbound transaction layer packets and decodes outbound transaction layer packets, the external port controller 15 may also include transaction layer circuitry for verifying that transaction layer packets are correctly formed, when conveying transaction layer packets between the bridge 12 and link partner 18.
a network layer 93, which in this example is according to the CXS protocol, but could also use other internal link protocols such as SFI, and for which the internal link control information is encoded/decoded by internal link interfaces at the bridge circuitry 12, internal communication link router 70 and external port controller 95. p1 the data link layer 94 defined according to PCIe (external link protocol), which is encoded/decoded by the link partner 18 and the data link layer encoding/decoding circuitry 40 of the external port controller 15.
the physical layer 95 defined according to PCIe (external link protocol), which is encoded/decoded by a PHY controller 42 associated with the root port 14 and by the link partner 18.

Hence, while the network layer 93 introduces another layer of encoding/decoding between the external port controller 15 and bridge 12, the use of CXS as the internal link protocol greatly simplifies the interface circuitry for encoding communications on the internal communication link 70, in comparison to other protocols such as AXI which require more specific mapping of external link protocol packets to a read/write specific format.

Concepts described herein may be embodied in a system comprising at least one packaged chip. The bridge circuitry and/or port controller described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

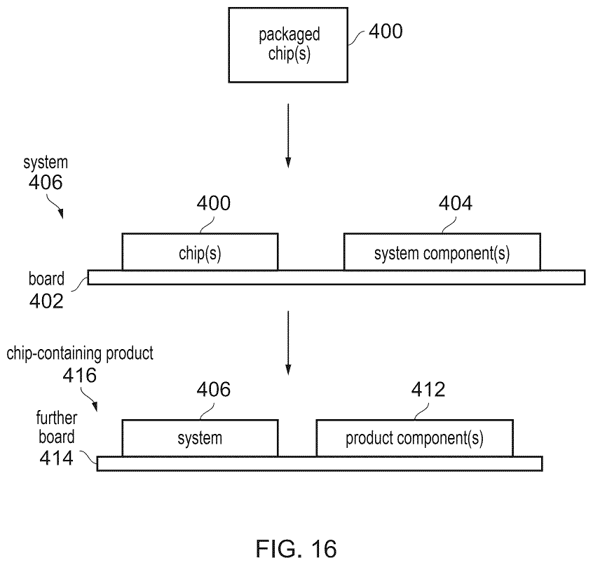

As shown in FIG. 16, one or more packaged chips 400, with the bridge circuitry 12 and/or port controller 15 described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. modular chips which, when combined, provide the functionality of a chip) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept. In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

Some configurations of the present techniques are described by the following numbered clauses:

Clause 1. An apparatus, comprising:
bridge circuitry configured to bridge between a memory system interconnect and a port controller, the port controller for communicating via an external communication link with a link partner, the bridge circuitry comprising an internal communication link interface configured to transmit packets via an internal communication link to the port controller; wherein
in a first state of the bridge circuitry, the bridge circuitry is configured to control the internal communication link interface to transmit a given type of packet to the port controller using a first type of credit; and
in a second state of the bridge circuitry, the bridge circuitry is configured to control the internal communication link interface to transmit the given type of packet to the port controller without using the first type of credit;
wherein the first type of credit represents availability of buffer storage at the link partner.

Clause 2. The apparatus according to claim 1, wherein the bridge circuitry is configured to receive a credit exchange message from the port controller indicating availability of the first type of credit.

Clause 3. The apparatus according to any preceding claim, wherein in the first state the bridge circuitry is configured to prohibit the internal communication link interface from transmitting the given type of packet to the port controller when there is no availability of the first

Clause 4. The apparatus according to any preceding claim, wherein in the second state of the bridge circuitry, the bridge circuitry is responsive to the given type of packet being a first type of packet to transmit the first type of packet using a second type of credit representing availability of buffer storage at the port controller.

Clause 5. The apparatus according to claim 4, wherein the first type of packet requests a completion response.

Clause 6. The apparatus according to any of claims 4 and 5, wherein the bridge circuitry is configured to manage an available number of the second type of credit independent of credit exchange messages from the port controller.

Clause 7. The apparatus according to claim 6, wherein the bridge circuitry is configured to increment an available number of the second type of credit in response to receipt of a completion packet from the port controller.

Clause 8. The apparatus according to any of claims 4 to 7, wherein in the first state of the bridge circuitry, the bridge circuitry is configured to control the internal communication link interface to transmit a packet targeting the port controller via the internal communication link using the second type of credit.

Clause 9. The apparatus according to any preceding claim, wherein in the second state of the bridge circuitry, the bridge circuitry is responsive to the given type of packet being a second type of packet to transmit the second type of packet without using any credits.

Clause 10. The apparatus according to claim 9, wherein the second type of packet comprises a packet for which no completion response is requested.

Clause 11. The apparatus according to any preceding claim, wherein in a third state of the bridge circuitry, the bridge circuitry is configured to prohibit the internal communication link interface from transmitting the given type of packet via the internal communication link.

Clause 12. The apparatus according to claim 11, wherein the bridge circuitry is configured to operate in one of six states: the first state, the second state, the third state, and three transitory states for transitioning into the first state, the second state, and the third state.
a port controller configured to control communication via an external communication link with a link partner, the port controller configured to receive packets via an internal communication link from bridge circuitry; wherein
in a first state of the port controller, the port controller is configured to receive packets via the internal communication link from the bridge circuitry and indicate availability of a first type of credit to the bridge circuitry; and
in a second state of the port controller, the port controller is configured to receive packets via the internal communication link from the bridge circuitry without indicating availability of the first type of credit to the bridge circuitry;
wherein the first type of credit represents availability of buffer storage at the link partner.

Clause 14. The apparatus according to claim 13, wherein in the first state and the second state the port controller is configured to issue response packets in response to at least a subset of packets received from the bridge circuitry.

Clause 15. The apparatus according to any of claims 13 and 14, wherein:
in the first state of the port controller, the port controller is configured to forward an given type of packet received from the bridge circuitry to the link partner; and
in the second state of the port controller, the port controller is configured to drop the given type of packet received from the bridge circuitry.

Clause 16. The apparatus according to any of claims 13 to 15, comprising buffer storage for storing a given subset of packets received from the bridge circuitry, wherein in the second state of the port controller, the given subset comprises packets for which a response is requested.

Clause 17. The apparatus according to any of claims 13 to 16, wherein the port controller is configured to indicate a lower availability of the first type of credit to the bridge circuitry than an amount of buffer storage indicated by the link partner.

Clause 18. The apparatus according to claim 17, wherein the port controller is configured to transmit a particular type of packet to the link partner using a reserved type of credit, the reserved type of credit corresponding to a difference between an availability of buffer storage at the link partner indicated to the bridge circuitry and an availability of buffer storage indicated to the port controller by the link partner.

Clause 19. The apparatus according to any preceding claim, wherein the port controller is for communicating external link protocol packets via the external communication link with the link partner, wherein the external link protocol packets are defined according to an external link protocol.

Clause 20. The apparatus according to claim 19, wherein the bridge circuitry is configured to use an internal link protocol to transmit packets via the internal communication link, wherein the internal link protocol provides a vessel for transporting the external link protocol packets encapsulated in an internal link protocol packet, without remapping of the external link protocol packets.

Clause 21. A system comprising:
the apparatus of any preceding claim, implemented in at least one packaged chip;
at least one system component; and
a board,
wherein the at least one packaged chip and the at least one system component are assembled on the board.

Clause 22. A chip-containing product comprising the system of claim 21, wherein the system is assembled on a further board with at least one other product component.

Clause 23. Computer-readable code for fabrication of the apparatus of any of claims 1 to 20.

### Clause 24. a Method, Comprising:

transmitting packets via an internal communication link from bridge circuitry, for bridging between a memory system interconnect and a port controller, the port controller for communicating via an external communication link with a link partner;
in a first state, transmitting a given type of packet via the internal communication link using a first type of credit; and
in a second state, transmitting the given type of packet via the internal communication link without using the first type of credit;
wherein the first type of credit represents availability of buffer storage at the link partner.

Clause 25. A method, comprising:
controlling communication via an external communication link for communicating with a link partner;
in a first state, receiving packets via an internal communication link from bridge circuitry and indicating availability of a first type of credit to the bridge circuitry; and
in a second state, receiving packets via the internal communication link from the bridge circuitry without indicating availability of the first type of credit to the bridge circuitry;
wherein the first type of credit represents availability of buffer storage at the link partner.

1. An apparatus, comprising:
bridge circuitry configured to bridge between a memory system interconnect and a port controller, the port controller for communicating via an external communication link with a link partner, the bridge circuitry comprising an internal communication link interface configured to transmit packets via an internal communication link to the port controller; wherein
in a first state of the bridge circuitry, the bridge circuitry is configured to control the internal communication link interface to transmit a given type of packet to the port controller using a first type of credit; and
in a second state of the bridge circuitry, the bridge circuitry is configured to control the internal communication link interface to transmit the given type of packet to the port controller without using the first type of credit;
wherein the first type of credit represents availability of buffer storage at the link partner.

2. The apparatus according to claim 1, wherein the bridge circuitry is configured to receive a credit exchange message from the port controller indicating availability of the first type of credit.

3. The apparatus according to claim 1, wherein in the first state the bridge circuitry is configured to prohibit the internal communication link interface from transmitting the given type of packet to the port controller when there is no availability of the first type of credit.

4. The apparatus according to claim 1, wherein in the second state of the bridge circuitry, the bridge circuitry is responsive to the given type of packet being a first type of packet to transmit the first type of packet using a second type of credit representing availability of buffer storage at the port controller.

5. The apparatus according to claim 4, wherein the first type of packet requests a completion response.

6. The apparatus according to claim 4, wherein the bridge circuitry is configured to manage an available number of the second type of credit independent of credit exchange messages from the port controller.

7. The apparatus according to claim 6, wherein the bridge circuitry is configured to increment an available number of the second type of credit in response to receipt of a completion packet from the port controller.

8. The apparatus according to claim 4, wherein in the first state of the bridge circuitry, the bridge circuitry is configured to control the internal communication link interface to transmit a packet targeting the port controller via the internal communication link using the second type of credit.

9. The apparatus according to claim 1, wherein in the second state of the bridge circuitry, the bridge circuitry is responsive to the given type of packet being a second type of packet to transmit the second type of packet without using any credits.

10. (canceled)

11. The apparatus according to claim 1, wherein in a third state of the bridge circuitry, the bridge circuitry is configured to prohibit the internal communication link interface from transmitting the given type of packet via the internal communication link.

12. (canceled)

13. An apparatus, comprising:
a port controller configured to control communication via an external communication link with a link partner, the port controller configured to receive packets via an internal communication link from bridge circuitry; wherein
in a first state of the port controller, the port controller is configured to receive packets via the internal communication link from the bridge circuitry and indicate availability of a first type of credit to the bridge circuitry; and
in a second state of the port controller, the port controller is configured to receive packets via the internal communication link from the bridge circuitry without indicating availability of the first type of credit to the bridge circuitry;
wherein the first type of credit represents availability of buffer storage at the link partner.

14. The apparatus according to claim 13, wherein
in the first state and the second state the port controller is configured to issue response packets in response to at least a subset of packets received from the bridge circuitry.

15. The apparatus according to claim 13, wherein:
in the first state of the port controller, the port controller is configured to forward an given type of packet received from the bridge circuitry to the link partner; and
in the second state of the port controller, the port controller is configured to drop the given type of packet received from the bridge circuitry.

16. The apparatus according to claim 13, comprising buffer storage for storing a given subset of packets received from the bridge circuitry, wherein in the second state of the port controller, the given subset comprises packets for which a response is requested.

17. The apparatus according to claim 13, wherein the port controller is configured to indicate a lower availability of the first type of credit to the bridge circuitry than an amount of buffer storage indicated by the link partner.

18. The apparatus according to claim 17, wherein the port controller is configured to transmit a particular type of packet to the link partner using a reserved type of credit, the reserved type of credit corresponding to a difference between an availability of buffer storage at the link partner indicated to the bridge circuitry and an availability of buffer storage indicated to the port controller by the link partner.

19-22. (canceled)

23. A non-transitory computer-readable storage medium storing computer-readable code for fabrication of the apparatus of claim 1.

24. A method, comprising:
transmitting packets via an internal communication link from bridge circuitry, for bridging between a memory system interconnect and a port controller, the port controller for communicating via an external communication link with a link partner;
in a first state, transmitting a given type of packet via the internal communication link using a first type of credit; and
in a second state, transmitting the given type of packet via the internal communication link without using the first type of credit;
wherein the first type of credit represents availability of buffer storage at the link partner.

25. A method, comprising:
controlling communication via an external communication link for communicating with a link partner;
in a first state, receiving packets via an internal communication link from bridge circuitry and indicating availability of a first type of credit to the bridge circuitry; and
in a second state, receiving packets via the internal communication link from the bridge circuitry without indicating availability of the first type of credit to the bridge circuitry;
wherein the first type of credit represents availability of buffer storage at the link partner.

26. A non-transitory computer-readable storage medium storing computer-readable code for fabrication of the apparatus of claim 13.
